(19) United States
(12) Patent Application Publication
(10) Pub. No.: US 2016/0234510 A1
(43) Pub. Date: Aug. 11, 2016

(54) Method of Coding for Depth Based Block Partitioning Mode in Three-Dimensional or Multi-view Video Coding

(71) Applicant: MEDIATEK INC., Hsin-Chu, Taiwan (CN)

(72) Inventors: Jian-Liang LIN, Su'ao Township, Yilan County (TW); Yi-Wen CHEN, Taichung City (TW); Xianguo ZHANG, Beijing (CN); Kai ZHANG, Beijing (CN); Jicheng AN, Beijing City (CN); Han HUANG, Beijing (CN)

(21) Appl. No.: 15/022,001

(22) PCT Filed: May 26, 2015
(86) PCT No.: PCT/CN2015/079761

§ 371 Date: Mar. 15, 2016

Related U.S. Application Data
(60) Provisional application No. 62/014,976, filed on Jun. 20, 2014.

(51) Int. Cl. H04N 19/174; H04N 19/50; H04N 19/597

(52) U.S. Cl. CPC H04N 19/174; H04N 19/597; H04N 19/50

(57) ABSTRACT

A method of video coding using coding modes including depth-based block partitioning (DBBP) in a multi-view or three-dimensional (3D) video coding system is disclosed. According to the present invention, when DBBP (depth-based block partition) is used to code a current texture coding unit, the DBBP partition mode is signaled so that the decoder does not need to go through complex computations to derive the DBBP partition mode. Various examples of determining the DBBP partition mode are disclosed.

### CROSS REFERENCE TO RELATED APPLICATIONS

The present invention claims priority to U.S. Provisional Patent Application, Ser. No. 62/014,976, filed on Jun. 20, 2014. The U. S. Provisional patent application is hereby incorporated by reference in its entirety.

### TECHNICAL FIELD

The present invention relates to three-dimensional (3D) or multi-view video coding. In particular, the present invention relates to coding for the depth-based block partitioning (DBBP) partition mode to simplify decoder complexity or coding performance.

### BACKGROUND

Three-dimensional (3D) television has been a technology trend in recent years that intends to bring viewers sensational viewing experience. Various technologies have been developed to enable 3D viewing. Among them, the multi-view video is a key technology for 3DTV application among others. The traditional video is a two-dimensional (2D) medium that only provides viewers a single view of a scene from the perspective of the camera. However, the 3D video is capable of offering arbitrary viewpoints of dynamic scenes and provides viewers the sensation of realism.

To reduce the inter-view redundancy, disparity-compensated prediction (DCP) has been used as an alternative to motion-compensated prediction (MCP). MCP refers to an inter-picture prediction that uses already coded pictures of the same view in a different access unit, while DCP refers to inter-picture prediction that uses already coded pictures of other views in the same access unit, as illustrated in FIG. 1. The three-dimensional/multi-view data consists of texture pictures (110) and depth maps (120). The motion compensated prediction is applied to texture pictures or depth maps in the temporal direction (i.e., the horizontal direction in FIG. 1). The disparity compensated prediction is applied to texture pictures or depth maps in the view direction (i.e., the vertical direction in FIG. 1). The vector used for DCP is termed disparity vector (DV), which is analog to the motion vector (MV) used in MCP.

3D-HEVC (3D video coding based on the High Efficiency Video Coding (HEVC) standard) is an extension of HEVC (High Efficiency Video Coding) that is being developed for encoding/decoding 3D video. One of the views is referred to as the base view or the independent view. The base view is coded independently of the other views as well as the depth data. Furthermore, the base view is coded using a conventional HEVC video coder.

In 3D-HEVC, a hybrid block-based motion-compensated DCT-like transform coding architecture is still utilized. The basic unit for compression, termed coding unit (CU), is a 2N×2N square block, and each CU can be recursively split into four smaller CUs until the predefined minimum size is reached. Each CU contains one or multiple prediction units (PUs). The PU size can be 2N×2N, 2N×N, N×2N, or N×N. When asymmetric motion partition (AMP) is supported, the PU size can also be 2N×nU, 2N×nD, nL×2N and nR×2N.

The 3D video is typically created by capturing a scene using video camera with an associated device to capture depth information or using multiple cameras simultaneously, where the multiple cameras are properly located so that each camera captures the scene from one viewpoint. The texture data and the depth data corresponding to a scene usually exhibit substantial correlation. Therefore, the depth information can be used to improve coding efficiency or reduce processing complexity for texture data, and vice versa. For example, the corresponding depth block of a texture block reveals similar information corresponding to the pixel level object segmentation. Therefore, the depth information can help to realize pixel-level segment-based motion compensation. Accordingly, a depth-based block partitioning (DBBP) has been adopted for texture video coding in the current 3D-HEVC.

In the depth-based block partitioning (DBBP) mode, arbitrarily shaped block partitioning for the collocated texture block is derived based on a binary segmentation mask computed from the corresponding depth map. Each of the two partitions (resembling foreground and background) is motion compensated and merged afterwards based on the depth-based segmentation mask.

A single flag is added to the coding syntax to signal to the decoder that the underlying block uses DBBP for prediction. When current coding unit is coded with the DBBP mode, the corresponding partition size is set to SIZE_2N×2N and bi-prediction is inherited.

A disparity vector derived from the DoNBDV (Depth-oriented Neighboring Block Disparity Vector) process is applied to identify a corresponding depth block in a reference view as shown in FIG. 2. In FIG. 2, corresponding depth block 220 in a reference view for current texture block 210 in a dependent view is located based on the location of the current texture block and derived DV 212, which is derived using DoNBDV according to 3D-HEVC standard. The corresponding depth block has the same size as current texture block. When the depth block is found, a threshold is calculated based on the average of all depth pixels within the corresponding depth block. Afterwards, a binary segmentation mask m_D (x,y) is generated based on depth values and the threshold. When the depth value located at the relative coordinator (x, y) is larger than the threshold, the binary mask m_D (x,y) is set to 1. Otherwise, m_D (x,y) is set to 0. An example is shown in FIG. 3. The mean value of the virtual block (310) is determined in step 320. The values of virtual depth samples are compared to the mean depth value in step 330 to generate segmentation mask 340. The segmentation mask is represented in binary data to indicate whether an underlying pixel belongs to segment 1 or segment 2, as indicated by two different line patterns in FIG. 3

The DoNBDV process enhances the NBDV by extracting a more accurate disparity vector from the depth map. The NBDV is derived based on disparity vector from neighboring blocks. The disparity vector derived from the NBDV process is used to access depth data in a reference view. A final disparity vector is then derived from the depth data.

The DBBP process partitions the 2N×2N block into two partitioned block. A motion vector is determined for each partition block. In the decoding process, each of the two decoded motion parameters is used for motion compensation performed on a whole 2N×2N block. The resulting prediction signals, i.e., p_T0 (x,y) and p_T1 (x,y) are combined using the DBBP mask m_D (x,y), as depicted in FIG. 4. The combination process is defined as follows

$$p\_T ( x , y ) = \{ \begin{matrix}p\_T 0 ( x , y ) , & if m\_D ( x , y ) = 1 \\ p\_T 1 ( x , y ) , & otherwise\end{matrix} . \qquad ( 1 )$$

By merging the two prediction signals, shape information from the depth map allows to independently compensate foreground and background objects in the same texture coding tree block (CTB). At the same time, DBBP does not require pixel-wise motion/disparity compensation. Memory access to the reference buffers is always regular (block-based) for DBBP-coded blocks in contrast to other irregular buffer-access approaches such as VSP. Moreover, DBBP always uses full-size blocks for compensation. This is preferable with respect to complexity because of the higher probability of finding the data in the memory cache.

In FIG. 4, the two prediction blocks are merged into one on a pixel by pixel basis according to the segmentation mask and this process is referred as bi-segment compensation. In this example, the N×2N block partition type is selected and two corresponding motion vectors (MV1 and MV2) are derived for two partitioned blocks respectively. Each of the motion vectors is used to compensate a whole texture block (410). Accordingly, motion vector MV1 is applied to texture block 420 to generate prediction block 430 according to motion vector MV1, and motion vector MV2 is applied to texture block 420 also to generate prediction block 432 according to motion vector MV2. The two prediction blocks are merged by applying respective segmentation masks (440 and 442) to generate the final prediction block (450).

Whether the DBBP mode is used is signaled in coding unit as shown in Table 1. In 3D-HEVC, prediction mode syntax (i.e., pat_mode) is signaled for a non-Intra coded block. Also, a DBBP flag is signaled at CU level to indicate whether current CU applies DBBP prediction. If it is DBBP mode, the transmitted partition mode is further replaced by the modified partition mode derived from the segmentation mask. FIG. 5 illustrates an example of deriving the modified partition mode according to the existing 3D-HEVC standard.

A co-located depth block 502 is used as an input to the process. Sub-sampled level mean value calculation is applied to the input depth block to determine the mean depth value of sub-samples depth data as shown in step 510. The contour of the depth block is determined by comparing the depth values with the mean depth value as shown in step 520. A segmentation mask 504 is obtained accordingly. Two candidate partitions 506 are used in this example for counting matched samples between the segmentation mask and the two-segment partitions as shown in step 530. After the numbers of matched samples for the candidate two-segment partitions are counted, the two-segment partition having the maximum number of matched samples is selected as the modified partition mode.

TABLE 1

| | Descriptor |
|---|---|
| coding_unit( x0, y0, log2CbSize , ctDepth) { | |
| . . . | |
| if( ( CuPredMode[ x0 ][ y0 ] != MODE_INTRA \| \| | |
| log2CbSize == MinCbLog2SizeY ) && | |
| !predPartModeFlag | |
| ) | |
| part_mode | ae(v) |
| if( depth_based_blk_part flag[ nuh_layer_id ] | |
| && CuPredMode[ x0 ][ y0 ] != MODE_INTRA ) | |
| dbbp_flag[ x0 ][ y0 ] | u(1) |
| . . . . | |
| } | |

In DBBP, the depth-derived segmentation mask needs to be mapped into one of the available rectangular partitioning modes. The mapping of the binary segmentation mask to one of the two-segment partitioning modes is performed by a correlation analysis. The best matching partitioning mode is selected for storing motion information and MVP derivation. The algorithm to derive the best matching partitioning mode is illustrated below.

After the encoder has derived the optimal motion/disparity information for each DBBP segment, this information is mapped into one of the available rectangular, non-square partitioning modes of HEVC. This includes asymmetric motion partitioning modes used by HEVC. The mapping of the binary segmentation mask to one of the 6 available two-segment partitioning modes is performed by a correlation analysis. For each of the available partitioning modes i, iε[0,5], 2 binary masks m_2i (x,y) and m_(2i+1) (x,y) are generated, where m_(2i+1) (x,y) is the negation of m_2i (x,y). Accordingly, there are 12 possible combinations of the segmentation mask/negation of segmentation mask and the 6 available two-segment partitions. To find the best matching partitioning mode, iopt for the current depth-based segmentation mask m_D (x,y), the following computations are performed:

$$\begin{matrix}{k}_{opt} = {argmax}_{k} {\sum }_{x}^{2 N - 1} {\sum }_{y}^{2 N - 1} {m}_{D} ( x , y ) * {m}_{k} ( x , y ) , k ∈ [ 0 , 11 ] & ( 2 ) \\ {i}_{opt} = ⌊ \frac{{k}_{opt}}{2} ⌋ , and & ( 3 ) \\ {b}_{inv} = \{ \begin{matrix}1 , & if {k}_{opt} is odd \\ 0 , & otherwise\end{matrix} . & ( 4 )\end{matrix}$$

The Boolean variable, bᵢₙᵥ defines whether the derived segmentation mask, m_{D}(x,y) needs to be inverted or not. This may be necessary in some cases, where the indexing of the conventional partitioning schemes is complementary to the indexing in the segmentation mask. In the conventional partitioning modes, index 0 always corresponds to the partition in the top-left corner of the current block, while the same index in the segmentation mask corresponds to the segment with the lower depth values (background objects). To align the positioning of the corresponding sets of motion information between m_{D}(x,y) and iₒₚₜ, the indexing in m_{D}(x,y) is inverted, if bᵢₙᵥ is set.

As described above, there are 12 sets of matched pixels need to be counted, which correspond to the combinations of 2 complementary segmentation masks and 6 block partition types. The block partition process selects the candidate having the largest number of matched pixels. FIG. 6 illustrates an example of block partition selection process. In FIG. 6, the 6 non-square block partition types are superposed on top of the segmentation mask and the corresponding inverted segmentation mask. A best matching partition between a block partition type and a segmentation mask is selected as the block partition for the DBBP process.

In the current standard, the decoder needs to derive the modified partition mode as illustrated in equations (2)-(4). The process involved fairly complex computations. Therefore, it is desirable to develop methods to simple the process for the decoder side.

### SUMMARY

A method of video coding using coding modes including depth-based block partitioning (DBBP) in a multi-view or three-dimensional (3D) video coding system is disclosed. According to the present invention, when DBBP (depth-based block partition) is used to code a current texture coding unit, the DBBP partition mode is signaled so that the decoder does not need to go through complex computations to derive the DBBP partition mode.

In one embodiment, the encoder determines a segmentation mask for the current texture coding unit based on co-located depth information and selects a DBBP (depth-based block partition) partition mode for the current texture coding unit. The encoder then generates two prediction blocks for the current texture coding unit from reference picture data using two motion vectors associated with partitioned blocks corresponding to the DBBP partition mode. A DBBP prediction block is generated by merging the two prediction blocks based on the segmentation mask. The current texture coding unit is then encoded using one or more predictors including the DBBP prediction block. If the current texture coding unit is coded using DBBP, a transmitted partition mode representing the DBBP partition mode selected is transmitted in the bitstream.

One aspect of the present invention addresses derivation of the transmitted partition mode. In one embodiment, the DBBP partition mode is selected by first determining a best PU (prediction unit) partition mode among 2N×N and N×2N partition modes in Inter/Merge modes according to RDO (rate-distortion optimization) results, then determining the RDO result associated with the DBBP partition mode based on the best PU partition mode, and selecting the DBBP partition mode if the RDO result associated with the DBBP partition mode is better than the RDO results associated with Intra mode and the 2N×N and N×2N partition modes in the Inter/Merge modes. Instead of selecting the best PU partition mode among 2N×N and N×2N partition modes in Inter/Merge modes, the best PU partition mode may also be selected from 2N×N, N×2N and asymmetric motion partition (AMP) partition modes in Inter/Merge modes.

In another embodiment, the DBBP partition mode is selected by determining RDO results for candidate DBBP partition modes corresponding to 2N×N and N×2N partition modes, then determining a best candidate DBBP partition mode that has a best RDO result between the 2N×N and N×2N partition modes, and selecting the best candidate DBBP partition mode as the DBBP partition mode if the RDO result associated with the best candidate DBBP partition mode is better than the RDO results associated with Intra mode and the 2N×N and N×2N partition modes in Inter/Merge modes. Instead of the 2N×N and N×2N partition modes used for determining the best candidate DBBP partition mode, AMP partition modes may also be included.

In yet another embodiment, the derivation process used in the existing 3D-HEVC standard may also be used. In this case, the maximum numbers of matched samples between the segmentation mask/negation of the segmentation mask and the 6 two-segment partition modes are counted. The two-segment partition mode having the maximum number of matched samples is selected as the transmitted partition mode.

The transmitted partition mode may also be skipped, i.e., not transmitted in the bitstream. In this case, a default transmitted partition mode, such as the 2N×N partition mode, can be used.

A corresponding method for the decoder side is also disclosed, where the decoder uses the transmitted partition mode for DBBP decoding instead of deriving the DBBP partition mode.

### BRIEF DESCRIPTION OF DRAWINGS

FIG. 1 illustrates an example of three-dimensional/multi-view coding, where motion compensated prediction (MCP) and disparity compensated prediction (DCP) are used

FIG. 2 illustrates an exemplary derivation process to derive a corresponding depth block in a reference view for a current texture block in a dependent view.

FIG. 3 illustrates an exemplary derivation process to generate the segmentation mask based on the corresponding depth block in a reference view for a current texture block in a dependent view.

FIG. 4 illustrates an exemplary processing flow for 3D or multi-view coding using depth-based block partitioning (DBBP).

FIG. 5 illustrates an example of derivation process for determining the modified partition mode as used in the existing 3D-HEVC standard.

FIG. 6 illustrates an example of matched a segmentation mask/negation of segmentation mask to one of 6 candidate two-segment partition modes.

FIG. 7 illustrates a flowchart of an exemplary encoding system incorporating an embodiment of the present invention to encoding the depth-based block partitioning (DBBP) partition mode.

FIG. 8 illustrates a flowchart of an exemplary decoding system incorporating an embodiment of the present invention to decoding the depth-based block partitioning (DBBP) partition mode.

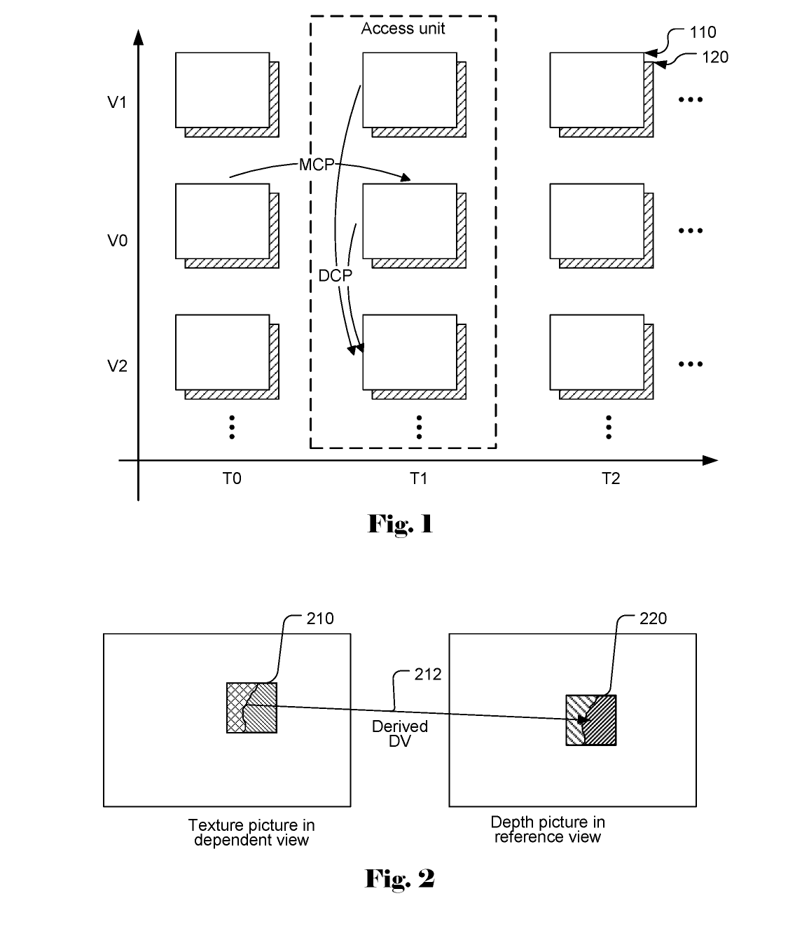

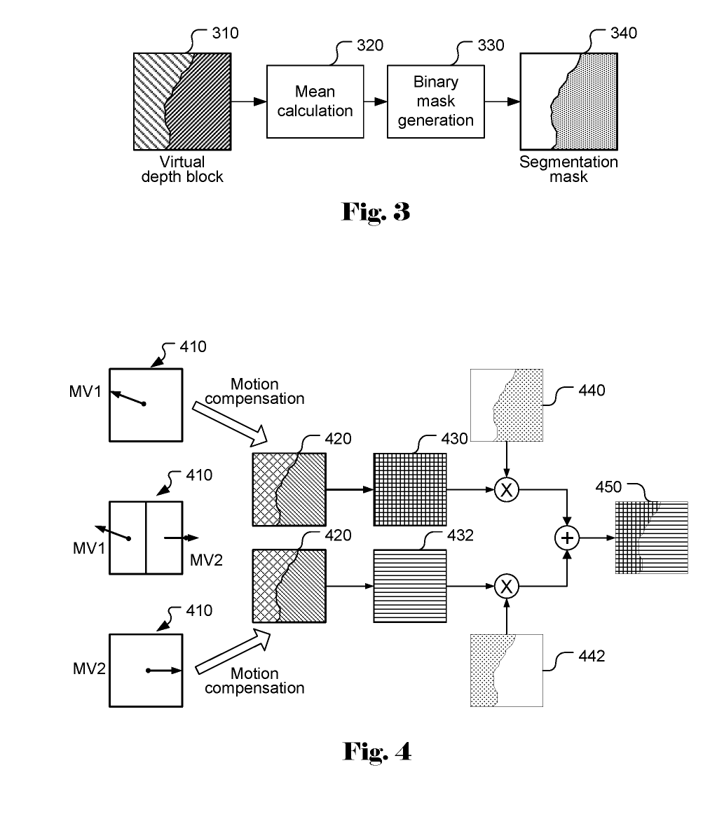

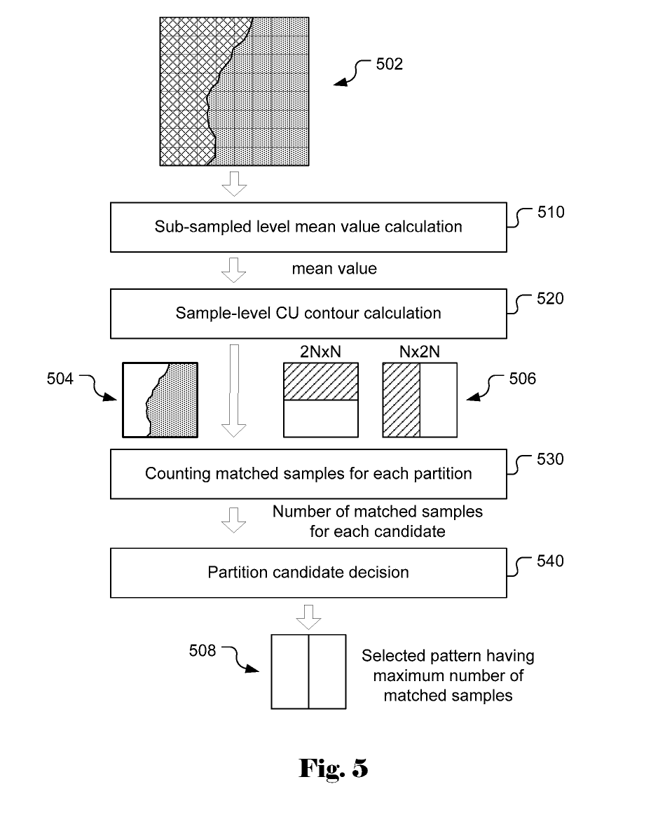

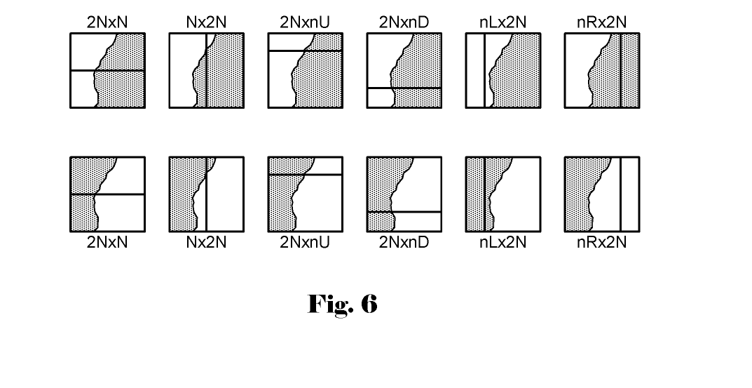

### DETAILED DESCRIPTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The present invention discloses a method to improve the DBBP prediction unit (PU) partition decision in 3D video coding. When the DBBP mode is enabled, the transmitted partition mode can be directly used as the DBBP partition mode for storing the motion information and MVP derivation. When the DBBP in enabled, the transmitted partition needs to be one of the rectangular partition modes (non-square rectangular partition modes). In order to avoid the computationally intensive process for deriving the DBBP partition mode at the decoder side, the present invention requires the encoder to transmit the DBBP partition mode when the DBBP is used for a current coding unit (CU). In the conventional DBBP mode, the partition mode (i.e., part_mode in Table 1) for the coding unit is signaled. However, the DBBP partition mode has to be determined by performing fairly complex process as shown in equations (2)-(4). Therefore, partition mode transmitted (i.e., part_mode in Table 1) is not used for determining the final DBBP partition mode. Therefore, the syntax element for partition mode can be used for signaling the DBBP partition mode according to one embodiment of the present invention. Nevertheless, new syntax may also be used to signal the DBBP partition mode. Therefore, the decoder-side DBBP partition derivation process is not needed.

According to the present invention, only the encoder needs to decide the PU partition for the DBBP mode and then transmitted it to the decoder. Various embodiments of the present inventions regarding DBBP partition mode determination at the encoder side are illustrated as follows.

In one embodiment, when the DBBP partition is enabled, the transmitted PU partition is decided at the encoder side according to the PU partition that achieves the best RDO results among 2N×N and N×2N Inter and/or Merge modes. Accordingly, the encoder determines a best PU (prediction unit) partition between the convention 2N×N and N×2N partition modes in the Inter/Merge modes. The best PU partition is then used as the candidate DBBP partition and the corresponding RDO result is computed. The RDO result associated with the candidate DBBP partition mode is compared to the RDO results of Intra modes and the 2N×N and N×2N partition modes in the Inter/Merge modes. If the RDO result associated with the candidate DBBP partition mode is the best, the candidate DBBP partition mode (i.e., the best PU partition) is used as the DBBP partition mode and is transmitted as the transmitted partition mode. The RDO refers to the widely used rate-distortion optimization process in video coding to select a best mode or parameter according to rate-distortion performance.

In another embodiment, when the DBBP partition is enabled, the transmitted PU partition is decided at the encoder side according to the PU partition that achieves the best RDO performance among 2N×N, N×2N, and AMP (asymmetric motion partition) partition modes in Inter and/or Merge modes. In this case, the best PU partition is determined among 2N×N, N×2N, and AMP partition modes instead of 2N×N and N×2N partition modes. The RDO result associated with the candidate DBBP partition mode (i.e., the best PU partition) is compared to the RDO results of Intra modes and the 2N×N, N×2N and AMP partition modes in the Inter/Merge modes. If the comparison result shows that the RDO result associated with the candidate DBBP partition mode is the best, the candidate DBBP partition mode is used as the DBBP partition mode and is transmitted as the transmitted partition mode.

In another embodiment, the encoder tests DBBP modes with PU partition equal to 2N×N or N×2N partition and selects one final PU partition among 2N×N and N×2N according to the RDO results. In other words, the encoder selects the DBBP partition mode by determining RDO results for candidate DBBP partition modes corresponding to 2N×N and N×2N partition modes. Then, the encoder determines a best candidate DBBP partition mode that has a best RDO result between the 2N×N and N×2N partition modes. The encoder selects the best candidate DBBP partition mode as the DBBP partition mode if the RDO result associated with the best candidate DBBP partition mode is better than the RDO results associated with Intra mode and the 2N×N and N×2N partition modes in Inter/Merge modes.

In another embodiment, the encoder tests DBBP modes with PU partition equal to 2N×N, N×2N, or one of AMP partitions and selects one final PU partition among those partitions according to the RDO results. In this case, the encoder selects the DBBP partition mode by determining RDO results for candidate DBBP partition modes corresponding to 2N×N, N×2N and AMP partition modes. The encoder selects the best candidate DBBP partition mode as the DBBP partition mode if the RDO result associated with the best candidate DBBP partition mode is better than the RDO results associated with Intra mode and the 2N×N, N×2N and AMP partition modes in Inter/Merge modes.

In another embodiment, the encoder derives a PU partition from a corresponding depth block and the depth-derived segmentation mask. For example, the encoder determines a best matching partition mode for the current depth-based segmentation mask m_{D}(x,y) according to equations (2)-(4). The best matching partition mode is transmitted to the decoder using the original partition mode syntax (i.e., part_mode). In this example, the best matching partition is selected from the two-segment partitioning modes or available non-square rectangular partitioning modes. The asymmetric motion partitioning (AMP) modes can be included or excluded from the potential partition modes.

In another embodiment, when the partition mode is signaled for a DBBP coded CU, the syntax for the partition mode can be tailored according to the particular partition modes used for DBBP CUs to optimize the coding performance. For example, if only 2N×N and N×2N partitions are allowed for a DBBP coded CU, only one bit is needed to indicate 2N×N or N×2N for the current DBBP CU.

In another embodiment, the partition mode is not signaled for a DBBP coded CU. The partition mode for a DBBP CU is fixed to a designated partition mode (i.e., default partition mode). For example, the 2N×N partition mode is always used for a DBBP CU for the storing of the motion information and MVP derivation.

The performance of video coding using coding modes including depth-based block partitioning (DBBP) in a multi-view or three-dimensional (3D) video coding system incorporating an embodiment of the present invention is compared to the performance of a conventional system based on HTM-11.0 (3D-HEVC Test Model version 11.0). The system incorporating an embodiment of the present invention achieves slightly better perform in term of BD-rate than the conventional system. In other words, the embodiment according to the present invention not only avoids the derivation process for the DBBP partition mode at the decoder side, but also achieves slight performance improvement.

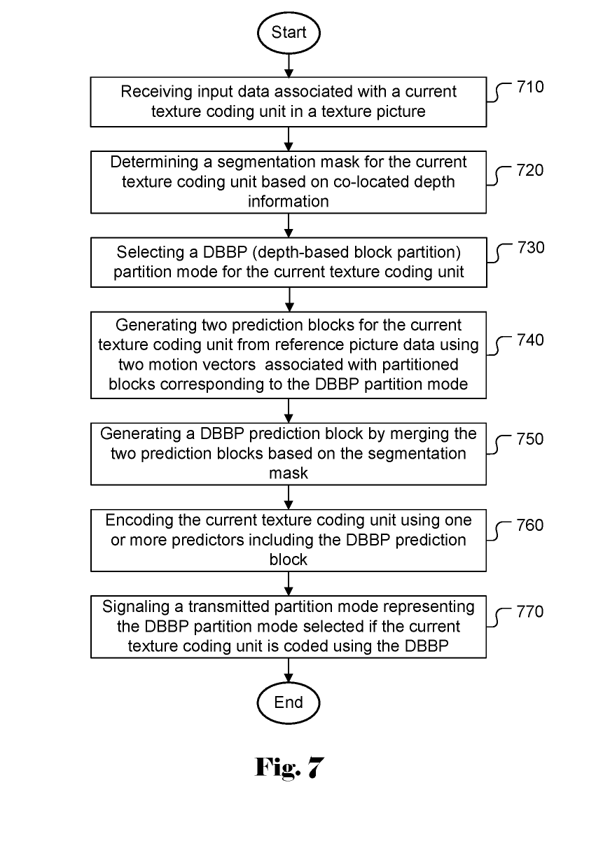

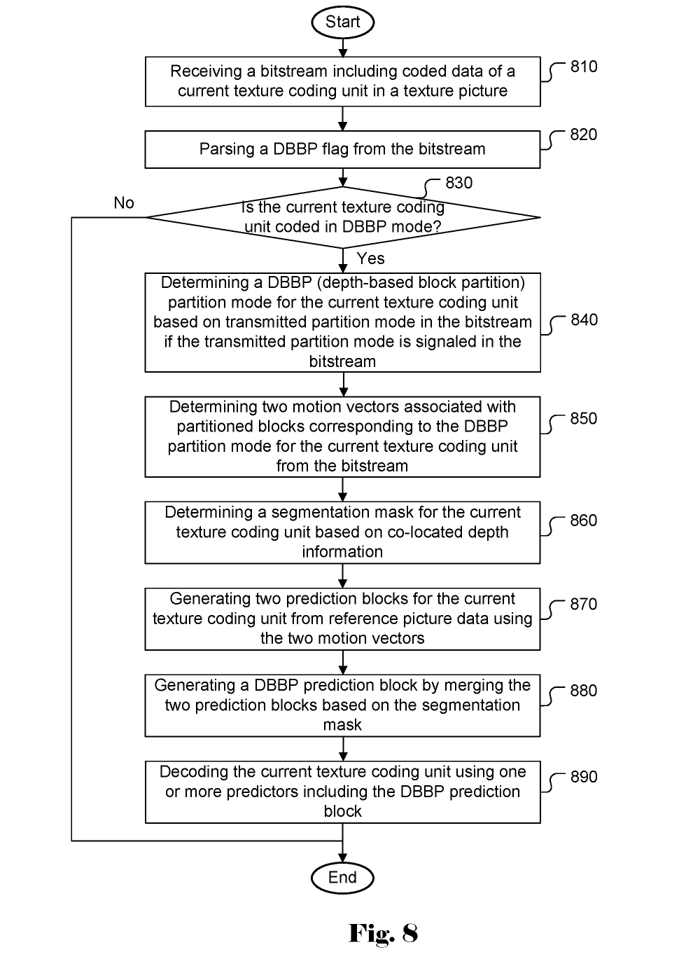

FIG. 7 illustrates a flowchart of an exemplary encoding system incorporating an embodiment of the present invention to encoding the depth-based block partitioning (DBBP) partition mode. Input data associated with a current texture coding unit in a texture picture is received in step 710. The input data may be retrieved from memory (e.g., computer memory, buffer (RAM or DRAM) or other media) or from a processor. A segmentation mask for the current texture coding unit is determined based on co-located depth information as shown in step 720. A DBBP (depth-based block partition) partition mode for the current texture coding unit is selected in step 730. Two prediction blocks for the current texture coding unit are generated from reference picture data using two motion vectors associated with partitioned blocks corresponding to the DBBP partition mode in step 740. A DBBP prediction block is generated by merging the two prediction blocks based on the segmentation mask in step 750. The current texture coding unit is generated using one or more predictors including the DBBP prediction block in step 760. A transmitted partition mode representing the DBBP partition mode selected is signaled in step 770 if the current texture coding unit is coded using the DBBP.

FIG. 8 illustrates a flowchart of an exemplary decoding system incorporating an embodiment of the present invention to decoding the depth-based block partitioning (DBBP) partition mode. The system receives a bitstream including coded data of a current texture coding unit in a texture picture as shown in step 810. The bitstream may be retrieved from memory (e.g., computer memory, buffer (RAM or DRAM) or other media) or from a processor. A DBBP flag is parsed from the bitstream in step 820. Whether the DBBP flag indicates that the current texture coding unit is coded in DBBP mode is checked in step 830. If the result is “Yes”, steps 840 through 890 are performed. If the result is “No”, steps 840 through 890 are skipped. In step 840, a DBBP (depth-based block partition) partition mode for the current texture coding unit is determined based on transmitted partition mode in the bitstream if the transmitted partition mode is signaled in the bitstream. In step 850, two motion vectors associated with partitioned blocks corresponding to the DBBP partition mode are determined for the current texture coding unit. The two motion vectors are, for example, derived based on one or more information (e.g., a merge candidate index) incorporated in the bitstream. In other embodiment, the two motion vectors are implicitly derived without any transmitted information in the bitstream. In step 860, a segmentation mask for the current texture coding unit is determined based on co-located depth information. In step 870, two prediction blocks for the current texture coding unit are generated from reference picture data using the two motion vectors. In step 880, a DBBP prediction block is generated by merging the two prediction blocks based on the segmentation mask. In step 890, the current texture coding unit is decoded using one or more predictors including the DBBP prediction block.

The flowcharts shown above are intended to illustrate examples of coding the depth-based block partitioning (DBBP) partition mode according to the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding using coding modes including depth-based block partitioning (DBBP) in a multi-view or three-dimensional (3D) video coding system, the method comprising:
receiving a bitstream including coded data of a current texture coding unit in a texture picture;
parsing a DBBP flag from the bitstream;
if the DBBP flag indicates that the current texture coding unit is coded in DBBP mode:
determining a DBBP (depth-based block partition) partition mode for the current texture coding unit based on transmitted partition mode in the bitstream if the transmitted partition mode is signaled in the bitstream;
determining two motion vectors associated with partitioned blocks corresponding to the DBBP partition mode for the current texture coding unit;
determining a segmentation mask for the current texture coding unit based on co-located depth information;
generating two prediction blocks for the current texture coding unit from reference picture data using the two motion vectors;
generating a DBBP prediction block by merging the two prediction blocks based on the segmentation mask; and
decoding the current texture coding unit using one or more predictors including the DBBP prediction block.

2. The method of claim 1, wherein the transmitted partition mode corresponds to an available non-square rectangular partition mode.

3. The method of claim 1, wherein the transmitted partition mode corresponds to a two-segment partition mode.

4. The method of claim 1, wherein if the transmitted partition mode is not signaled in the bitstream, a default partition mode is used as the transmitted partition mode.

5. The method of claim 4, wherein the default partition mode corresponds to 2N×N partition mode.

6. The method of claim 1, wherein the transmitted partition mode corresponds to an asymmetric motion partitioning (AMP) mode.

7. A method of video encoding using coding modes including depth-based block partitioning (DBBP) in a multi-view or three-dimensional (3D) video coding system, the method comprising:
receiving input data associated with a current texture coding unit in a texture picture;
determining a segmentation mask for the current texture coding unit based on co-located depth information;
selecting a DBBP (depth-based block partition) partition mode for the current texture coding unit;
generating two prediction blocks for the current texture coding unit from reference picture data using two motion vectors associated with partitioned blocks corresponding to the DBBP partition mode;
generating a DBBP prediction block by merging the two prediction blocks based on the segmentation mask;
encoding the current texture coding unit using one or more predictors including the DBBP prediction block; and
signaling a transmitted partition mode representing the DBBP partition mode selected if the current texture coding unit is coded using the DBBP.

8. The method of claim 7, wherein the DBBP partition mode is selected by firstly determining a best PU (prediction unit) partition mode among 2N×N and N×2N partition modes in Inter/Merge modes according to RDO (rate-distortion optimization) results, then determining the RDO result associated with the DBBP partition mode based on the best PU partition mode, and selecting the DBBP partition mode if the RDO result associated with the DBBP partition mode is better than the RDO results associated with Intra mode and the 2N×N and N×2N partition modes in the Inter/Merge modes.

9. The method of claim 7, wherein the DBBP partition mode is selected by firstly determining a best PU (prediction unit) partition mode among 2N×N, N×2N and AMP (asymmetric motion partition) partition modes in Inter/Merge modes according to RDO (rate-distortion optimization) results, then determining the RDO results associated with the DBBP partition based on the best PU partition mode, and selecting the DBBP partition mode if the RDO result associated with the DBBP partition mode is better than the RDO results associated with Intra mode and the 2N×N, N×2N and AMP partition modes in the Inter/merge modes.

10. The method of claim 7, wherein the DBBP partition mode is selected by determining RDO (rate-distortion optimization) results for candidate DBBP partition modes corresponding to 2N×N and N×2N partition modes, then determining a best candidate DBBP partition mode that has a best RDO result between the 2N×N and N×2N partition modes, and selecting the best candidate DBBP partition mode as the DBBP partition mode if the RDO result associated with the best candidate DBBP partition mode is better than the RDO results associated with Intra mode and the 2N×N and N×2N partition modes in Inter/Merge modes.

11. The method of claim 7, wherein the DBBP partition mode is selected by determining RDO (rate-distortion optimization) results for candidate DBBP partition modes corresponding to 2N×N, N×2N and AMP (asymmetric motion partition) partition modes, then determining a best candidate DBBP partition mode that has a best RDO result between the 2N×N and N×2N partition modes, and selecting the best candidate DBBP partition mode as the DBBP partition mode if the RDO result associated with the best candidate DBBP partition mode is better than the RDO results associated with Intra mode and the 2N×N, N×2N and AMP partition modes in Inter/Merge modes.

12. The method of claim 7, wherein the DBBP partition mode is selected according to a best candidate two-segment partition mode a having highest match count with the segmentation mask among all candidate two-segment partition modes.

13. The method of claim 7, wherein syntax for the transmitted partition mode is coded according to candidate partition modes including the transmitted partition mode to optimize coding performance.

14. An apparatus for video decoding using coding modes including depth-based block partitioning (DBBP) in a multi-view or three-dimensional (3D) video coding system, the apparatus comprising one or more electronic circuits configured to:
receive a bitstream including coded data of a current texture coding unit in a texture picture;
parse a DBBP flag from the bitstream;
if the DBBP flag indicates that the current texture coding unit is coded in DBBP mode:
determine a DBBP (depth-based block partition) partition mode for the current texture coding unit based on transmitted partition mode in the bitstream if the transmitted partition mode is signaled in the bitstream;
determine two motion vectors associated with partitioned blocks corresponding to the DBBP partition mode for the current texture coding unit;
determine a segmentation mask for the current texture coding unit based on co-located depth information;
generate two prediction blocks for the current texture coding unit from reference picture data using the two motion vectors;
generate a DBBP prediction block by merging the two prediction blocks based on the segmentation mask; and
decode the current texture coding unit using one or more predictors including the DBBP prediction block.
